(19) United States
(12) Patent Application Publication
(10) Pub. No.: US 2005/0070261 A1
(43) Pub. Date: Mar. 31, 2005

(54) Method, apparatus and system for managing cell phone calls

(76) Inventors: Brian V. Belmont, Portland, OR (US); Muthu K. Kumar, Hillsboro, OR (US)

Correspondence Address: INTEL CORPORATION, P.O. BOX 5326, SANTA CLARA, CA, 95056-5326, US

(21) Appl. No.: 10/676,700

(22) Filed: Sep. 30, 2003

(51) Int. Cl. H04Q 7/00

(52) U.S. Cl. 455/415; 455/567; 455/412.1

(57) ABSTRACT

A method, apparatus and system enable users to utilize their personal computers (“PCs”) to manage incoming cell phone calls. A cell phone may be coupled to a PC, and the PC may be configured to notify the user of incoming calls or to automatically respond to incoming calls. If the user is notified, an application on the PC may enable the user to view information associated with the call, and select a response option to handle the call. If the PC is configured to respond automatically, the PC may select an appropriate response for the incoming call.

### FIELD

The present invention relates to the field of cell phone call management, and, more particularly, a method, apparatus and system for using a data processing device to manage cell phone calls.

### BACKGROUND

Cell phones are becoming increasingly popular today. Currently, when users receive incoming calls on their cell phones, they have to stop whatever they are doing, locate their cell phone, review the caller ID information and then decide whether to answer the call or allow their voice mail system to pick up the call. Alternatively, the users may simply ignore the call and allow it to be picked up by their voice mail system. Neither alternative provides the user with significant flexibility in deciding whether and/or how to respond to incoming calls on their cell phones. Further complicating the issue is the fact that if the caller's name is not programmed in the limited local phonebook stored on the cell phone, the user will only see the caller's phone number displayed, rather than a more user friendly name.

### BRIEF DESCRIPTION OF THE DRAWINGS

The present invention is illustrated by way of example and not limitation in the figures of the accompanying drawings in which like references indicate similar elements, and in which:

FIG. 1 illustrates an embodiment of the present invention;

FIG. 2 illustrates an example user interface screen for an application running on PC 100 according to an embodiment of the present invention;

FIG. 3 illustrates an example user interface screen for a user to select one of a variety of voicemail responses; and

FIG. 4 is a flow chart illustrating an embodiment of the present invention.

### DETAILED DESCRIPTION

Embodiments of the present invention provide a method, apparatus and system for utilizing a data processing device for personal management of incoming cell phone calls. Hereafter, the data processing device is referred to as a personal computer (“PC”) but embodiments of the invention are not so limited. Additionally, as used herein, the term “cell phone” shall include, but not be limited to cellular telephones and/or any device capable of enabling a user to receive communications. Reference in the specification to “one embodiment” or “an embodiment” of the present invention means that a particular feature, structure or characteristic described in connection with the embodiment is included in at least one embodiment of the present invention. Thus, the phrases “in one embodiment”, “according to one embodiment” or the like appearing in various places throughout the specification are not necessarily all referring to the same embodiment.

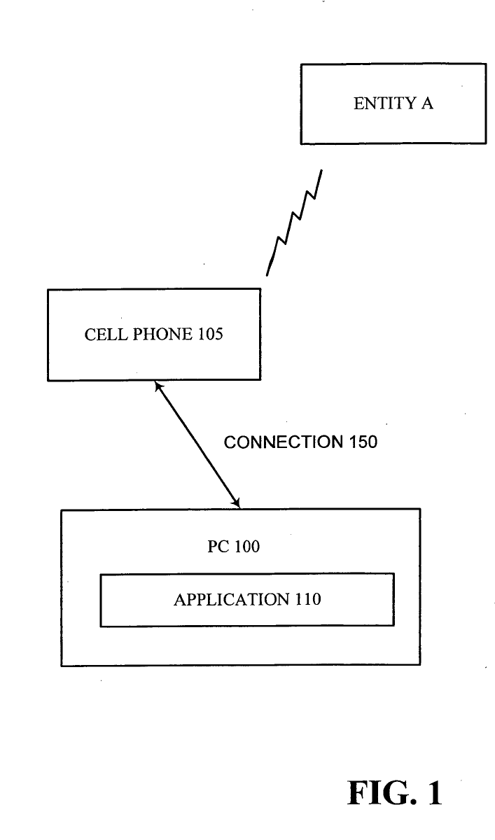

According to an embodiment of the present invention, a PC may be utilized to manage incoming calls on a cell phone. FIG. 1 illustrates an embodiment of the present invention. As illustrated, PC 100 may be coupled to Cell Phone 105 via Connection 150. Connection 150 may include any type of wired connection (serial and/or Universal Serial Bus) and/or wireless connection operating in licensed or unlicensed spectrum. Examples of Connection 150 include, but are not limited to, Bluetooth (Version 1.1, Feb. 22, 2001), Institute of Electrical and Electronics Engineers (“IEEE”) 802.11 (IEEE, 1999) and/or proprietary protocols in the 900 MHz, 2.4 GHz, or 5 GHz bands. These protocols, and others, are well known to those of ordinary skill in the art and further description thereof is omitted herein in order not to unnecessarily obscure embodiments of the present invention. Additionally, Connection 150 may also comprise other current and future technology such as Zigbee technology and Ultra Wide Band (“UWB”) technology (both currently under development by IEEE).

In one embodiment, when Cell Phone 105 receives a call from Entity A, the call may be intercepted by PC 100. Application 110 may be launched on PC 100 to enable the user on PC 100 to manage the incoming call. In various embodiments, Application 110 may be activated in a variety of ways. For example, Application 110 may be activated when Cell Phone 105 is coupled to PC 110. Alternatively, Application 110 may be activated when an incoming call is detected for Cell Phone 105. It will be readily apparent to those of ordinary skill in the art that Application 110 may be implemented in software, hardware and/or a combination thereof. It will additionally be apparent to those of ordinary skill in the art that Application 110 may be implemented as a single module including all functionality described herein and/or as separate modules which together provide such functionality. Additionally, although illustrated in FIG. 1 as residing on PC 100, Application 110 may also reside on Cell Phone 105 and/or in part on both PC 100 and Cell Phone 105 without departing from the spirit of embodiments of the present invention.

In one embodiment, when Application 110 detects an incoming call on PC 105, Application 110 may retrieve and display information associated with the call. Unlike a current cell phone call, however, where a caller's name will also be displayed only if his name is already in Cell Phone 105's local phone book, in one embodiment, Application 110 may also retrieve the caller's name from a variety of other sources. For example, if Entity A's name is not entered in Cell Phone 105's local phone book, Application 110 may retrieve the information from a phone book or address book stored on PC 100. Alternatively, Application 110 may retrieve the information from a remote source coupled to PC 100. In yet another embodiment, the information may be transmitted with the call as caller ID information. Application 110 may also be configured to retrieve a variety of other information associated with the call, if the information is available.

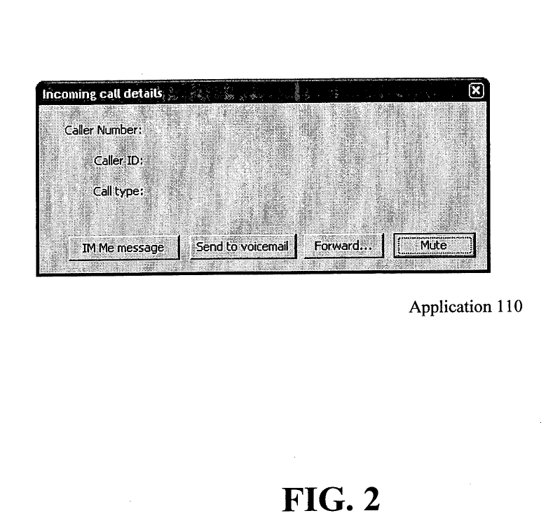

Furthermore, in one embodiment, Application 110 may enable the user to actively manage his calls and/or configure PC 100 to automatically manage his calls. If PC 100 is configured to automatically manage the user's calls, then when the incoming call signal is received, Application 110 may examine the user preferences to determine whether the user desires to be notified of the call or whether PC 100 should automatically select an appropriate response. If the user's preferences indicate that the user desires to be notified of the call, then Application 110 may be displayed on the display device coupled to PC 100. FIG. 2 illustrates an example user interface screen for Application 110 on PC 100. In this example, Application 110 includes a display of Entity A's phone number, Entity A's caller ID (if any), as well as a variety of options for the user to manage the call. Thus, for example, the user may ignore the call by selecting the “Mute Ringer” option. Alternatively, in another embodiment, the user may elect “Send to Voicemail” to send the call directly to voicemail. In yet other embodiments, the user may elect to “Forward” the call to another phone number and/or have the message sent to him (e.g., “IM Me Message”).

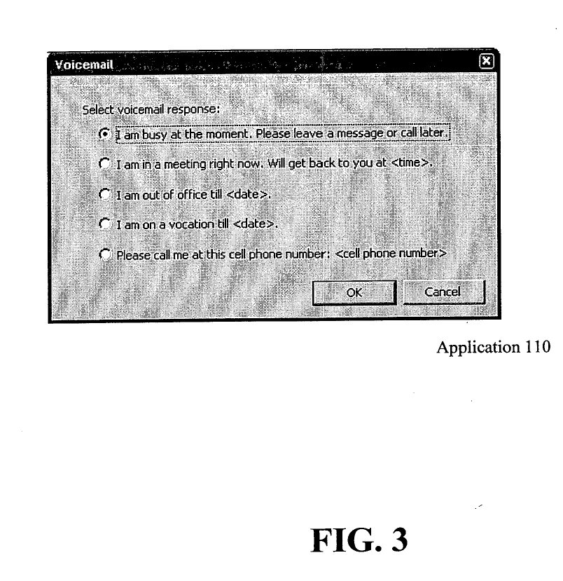

In yet another embodiment, when the user selects the “Send to Voicemail” option, the user may be presented with a selection of voice responses to respond to the call. For example, the user may have previously recorded a variety of responses, and when the call comes in, he may select one of the preprogrammed responses to use as a response to this call, instead of his default voicemail message. FIG. 3 illustrates an exemplary user interface via which a user may make such a selection. Alternatively, the user may be able to type in a response in real-time in Application 110 and a text-to-speech application on PC 100 may convert the user's text into an appropriate verbal response. Details of text-to-speech applications are well known to those of ordinary skill in the art and further description thereof is omitted herein in order not to unnecessarily obscure embodiments of the present invention. Regardless of how the responses are generated, it will be readily apparent to those of ordinary skill in the art that the screen illustrated in FIG. 2 is merely exemplary and that a variety of other user interfaces may be utilized without departing from the spirit of embodiments of the present invention.

In an embodiment of the present invention, Application 110 may also be configured to automatically respond to an incoming call based on a variety of factors. Thus, for example, Application 110 may determine based on the user's calendar that the user is in a meeting when the call comes in. As such, Application 110 may be configured to automatically turn off the ringer on the user's cell phone and/or select an appropriate response from a list of predefined responses. It will be readily apparent to those of ordinary skill in the art that Application 110 may be configured to include a variety of such intelligent behavior.

In one embodiment of the present invention, “Attention Command” (“AT”) commands may be used to facilitate communications between Cell Phone 105 and PC 100. AT commands are industry standard commands developed by Hayes Corporation for PCs to communicate with modems. These commands were adopted by the cellular communications industry in the Global System for Mobile communications (“GSM”) specification 07.07 (Version 5.0.0, December 1999]. These commands have also been extended for use with other devices such as phones and facsimile machines. Typically, each device vendor adds commands to the standard set of AT commands to create an extended AT command set specific for their devices. Since these commands are well known to those of ordinary skill in the art, further description thereof is omitted herein in order not to unnecessarily obscure embodiments of the present invention. In one embodiment, if Cell Phone 105 supports and/or recognizes AT commands, various extensions may be added to AT command set to enable the user to manage his call phone calls.

In other embodiments, instead of using AT commands, other types of communications mechanisms may be utilized. For example, Cell Phone 105 may include other programming capabilities (e.g., C and/or C++) that may be utilized instead to send and receive commands from PC 100 using a standard or proprietary serial protocol. Alternatively, if Connection 150 is an 802.11 connection, commands may be sent over Transport Control Protocol/Internet Protocol (“TCP/IP”). Use of TCP/IP packets is well known to those of ordinary skill in the art and further description thereof is omitted herein.

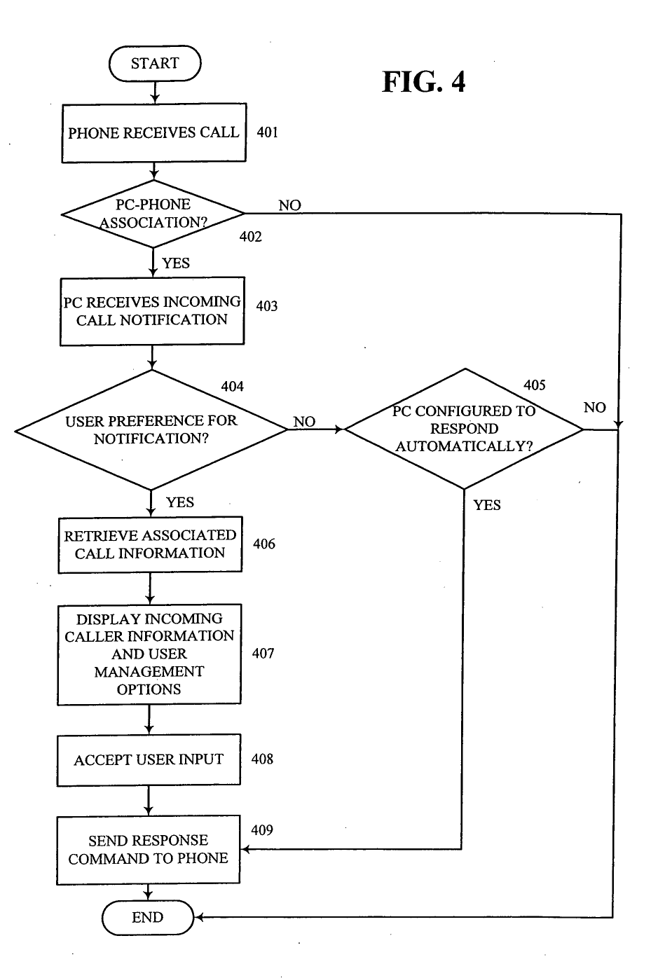

FIG. 4 is a flow chart illustrating an embodiment of the present invention. Although the following operations may be described as a sequential process, many of the operations may in fact be performed in parallel or concurrently. In addition, the order of the operations may be re-arranged without departing from the spirit of embodiments of the invention. In 401, a cell phone receives a call. In 402, the cell phone is examined to determine if it is coupled to a PC. If the cell phone is not coupled to the PC, then the cell phone will behave as it typically does, i.e., the user may either pick up the call or allow his voice mail to pick up. If, however, the cell phone is coupled to the PC, then in 403, the PC receives notification that there is an incoming call on the cell phone.

In 404, the PC configuration may be examined to determine the user's preferences for notification. If the user has indicated that he does not wish to be notified of incoming calls, then the PC configuration may be examined further to determine whether the user has configured the PC to respond automatically to incoming calls. If there is no additional configuration, then once again, the cell phone may behave as it typically does, i.e., the call may be picked up by voice mail. If the user has configured the PC to respond automatically, then a command corresponding to the selected response may be transmitted from the PC to the cell phone in 405.

If, however, the user has indicated that he wants to be notified every time a call comes in on his cell phone, then in 406, PC 100 may retrieve the associated call information (e.g., name of caller corresponding to the phone number) from at least one of a variety of locations. In one embodiment, the information resides in the cell phone local phone book. In alternate embodiments of the invention, the information resides on the PC and/or at a source coupled to the PC. This retrieved information may be displayed on the display device coupled to PC 100 in 407, together with various call management options available to the user. When the user makes a selection, the user input is accepted in 408, and in 409, a command corresponding to the user's selected response may be transmitted from the PC to the cell phone.

Although described herein as being implemented on PCs, embodiments of the present invention may be implemented on a variety of data processing devices. It will be readily apparent to those of ordinary skill in the art that these data processing devices may include various types of software, firmware and hardware. According to an embodiment of the present invention, the data processing devices may also include various components capable of executing instructions to accomplish an embodiment of the present invention. For example, the data processing devices may include and/or be coupled to at least one machine-accessible medium. As used in this specification, a “machine” includes, but is not limited to, any data processing device with one or more processors. As used in this specification, a machine-accessible medium includes any mechanism that stores and/or transmits information in any form accessible by a data processing device, the machine-accessible medium including but not limited to, recordable/non-recordable media (such as read only memory (ROM), random access memory (RAM), magnetic disk storage media, optical storage media and flash memory devices), as well as electrical, optical, acoustical or other form of propagated signals (such as carrier waves, infrared signals and digital signals).

According to an embodiment, a data processing device may include various other well-known components such as one or more processors. The processor(s) and machine-accessible media may be communicatively coupled using a bridge/memory controller, and the processor may be capable of executing instructions stored in the machine-accessible media. The bridge/memory controller may be coupled to a graphics controller, and the graphics controller may control the output of display data on a display device. Similarly, an audio adapter may be coupled to the bridge/memory controller to control the output of audio to a speaker. The bridge/memory controller may be coupled to one or more buses. A host bus controller such as a Universal Serial Bus (“USB”) host controller may be coupled to the bus(es) and a plurality of devices may be coupled to the USB. For example, user input devices such as a keyboard and mouse may be included in the data processing device for providing input data. The data processing device may additionally include a network interface (e.g., a network interface card and/or a modem) capable of coupling the device to a network.

In the foregoing specification, the invention has been described with reference to specific exemplary embodiments thereof. It will, however, be appreciated that various modifications and changes may be made thereto without departing from the broader spirit and scope of embodiments of the invention, as set forth in the appended claims. The specification and drawings are, accordingly, to be regarded in an illustrative rather than a restrictive sense.

1. A method of managing an incoming call on a cell phone, comprising:
receiving notification of the incoming call on a data processing device;
retrieving information associated with the incoming call; and
enabling a user to manage the incoming call by selecting an appropriate response.

2. The method according to claim 1 wherein retrieving the information associated with the incoming call further comprises at least one of:
retrieving the information from the cell phone;
retrieving the information from the data processing device; and
retrieving the information from a source coupled to the data processing device.

3. The method according to claim 1 wherein enabling the user to manage the incoming call further comprises one of:
enabling the user to configure a personal computer to automatically select the appropriate response; and
enabling the user to actively select the appropriate response.

4. The method according to claim 3 wherein the appropriate response includes at least one of forwarding the incoming call, requesting a sender of the incoming call to send an instant message and responding to the incoming call with a voicemail message.

5. The method according to claim 4 wherein responding to the incoming call with the voicemail message further comprises selecting one of a plurality of voicemail messages as the appropriate response.

6. The method according to claim 1 wherein receiving the incoming call further comprises receiving a signal from the cell phone indicating the incoming call.

7. The method according to claim 6 wherein the signal is an Attention Command (“AT”) signal.

8. An article comprising a machine-accessible medium having stored thereon instructions that, when executed by a machine, cause the machine to manage an incoming call on a cell phone coupled to the machine by:
receiving notification of the incoming call on the machine;
retrieving information associated with the incoming call; and
enabling a user to manage the incoming call by selecting an appropriate response.

9. The article according to claim 8 wherein the instructions, when executed by the machine, further cause the machine to retrieve the information associated with the incoming call by:
retrieving the information from the cell phone;
retrieving the information from the data processing device; and
retrieving the information from a source coupled to the data processing device.

10. The article according to claim 8 wherein the instructions, when executed by the machine, further cause the machine to manage the incoming call by:
enabling the user to configure a personal computer to automatically select the appropriate response; and
enabling the user to actively select the appropriate response.

11. The article according to claim 10 wherein the instructions, when executed by the machine, further cause the machine to manage the incoming call by at least one of forwarding the incoming call, requesting a sender of the incoming call to send an instant message and responding to the incoming call with a voicemail message.

12. The article according to claim 11 wherein the instructions, when executed by the machine, further cause the machine to enable selection of one of a plurality of voicemail messages as the appropriate response.

13. The article according to claim 8 wherein the instructions, when executed by the machine, further cause the machine to receive a signal from the cell phone indicating the incoming call.

14. The article according to claim 13 wherein the signal is an Attention Command (“AT”) signal.

15. A data processing device for managing an incoming call on a cell phone, comprising:
a receiving module capable of receiving notification of the incoming call;
a processing module capable of retrieving information associated with the incoming call; and
a response module capable of enabling a user to manage the incoming call by selecting an appropriate response.

16. The data processing device according to claim 15 wherein the processing module retrieves the information associated with the incoming call from at least one of the cell phone, the data processing device and a source coupled to the data processing device.

17. The data processing device according to claim 15 wherein the response module enables the user to manage the incoming call by at least one of:
enabling the user to configure the data processing device to automatically select the appropriate response; and
enabling the user to actively select the appropriate response.

18. The data processing device according to claim 17 wherein the response module enables the user to manage the incoming call by at least one of forwarding the incoming call, requesting a sender of the incoming call to send an instant message and responding to the incoming call with a voicemail message.

19. The data processing device according to claim 18 wherein the response module enables the user to respond to the incoming call with the voicemail message by selecting one of a plurality of voicemail messages as the appropriate response.

20. The data processing device according to claim 15 wherein the receiving module further receives a signal from the cell phone indicating the incoming call.

21. The data processing device according to claim 20 wherein the signal is an Attention Command (“AT”) signal.

22. A system for managing an incoming call on a cell phone, comprising:
a data processing device capable of receiving notification of the incoming call; an application coupled to the data processing device, the application capable of retrieving information associated with the incoming call, the application further capable of enabling a user to manage the incoming call by selecting an appropriate response.

23. The system according to claim 22 wherein the application is capable of retrieving the information associated with the incoming call from at least one of the cell phone, a source on the data processing device and a source coupled to the data processing device.

24. The system according to claim 22 wherein the application is further capable of enabling the user to manage the incoming call by at least one of:
enabling the user to configure the data processing device to automatically select the appropriate response; and
enabling the user to actively select the appropriate response.

25. The system according to claim 24 wherein the application is further capable of enabling the user to manage the incoming call by at least one of forwarding the incoming call, requesting a sender of the incoming call to send an instant message and responding to the incoming call with a voicemail message.

26. The system according to claim 25 wherein the application is further capable of responding to the incoming call with the voicemail message by selecting one of a plurality of voicemail messages as the appropriate response.

27. The system according to claim 22 wherein the application is further capable of receiving a signal from the cell phone indicating the incoming call.

28. The system according to claim 27 wherein the signal is an Attention Command (“AT”) signal.
